(19) United States
(12) Patent Application Publication
(10) Pub. No.: US 2011/0303119 A1
(43) Pub. Date: Dec. 15, 2011

(54) Anti-splatter metal cutting formulation

(76) Inventor: Stephan C. Leitner, Tacoma, WA (US)

(21) Appl. No.: 13/134,503

(22) Filed: Jun. 8, 2011

Related U.S. Application Data
(60) Provisional application No. 61/353,657, filed on Jun. 11, 2010.

(51) Int. Cl. C09D 191/00

(52) U.S. Cl. 106/243

(57) ABSTRACT

An anti-spatter formulation, for use in all manner of cutting, welding or grinding of metal materials, and specifically for providing a liquid barrier that withstands sparks, to protect the metal material from all manner of adhesion and damage by liquid molten metal or sparks, also known as spatter or splatter. The anti-spatter formulation includes lecithin and the anti-spatter formulation is applied to a metal surface to form a barrier. The metal surface is protected by the barrier, from a spark and spatter damage. The anti-spatter formulation of claim is preferably a soy derived lecithin, and additionally mixed with n-propyl bromide.

This Non-Provisional Utility Application claims priority to Provisional Patent Application Ser. No. 61/353,657, as filed Jun. 11, 2010.

### TECHNICAL FIELD

An anti-spatter formulation, for use in all manner of cutting, welding or grinding of metal materials, and specifically for providing a liquid barrier that withstands sparks, to protect the metal material from all manner of adhesion and damage by liquid molten metal or sparks, also known as spatter or splatter.

### BACKGROUND OF THE INVENTION

Many metalworking operations involved in the manufacture of products generate sparks, such as welding, laser cutting or grinding. Anti-spatter products and formulations are employed to provide a barrier, when applied to metal materials. The barrier withstands sparks, and therefore protects the metal materials from spatter or splatter. Some anti-spatter products presently on the market are water based, and not very effective. Other products contain harsh chemicals, such as methylene chloride, which is considered hazardous to the environment and humans. An anti-spatter formulation for use in laser cutting of metal materials is needed that is non-ozone depleting and has a lower toxicity to humans, as compared to current anti-spatter products.

The following is a disclosure of the present invention that will be understood by reference to the following detailed description.

### DETAILED DESCRIPTION OF SPECIFIC EMBODIMENTS

The invention provides an Anti-Spatter Formulation for use in laser cutting of metal materials. The anti-spatter formulation is applied by the following methods but is not limited to brushing, sprayed or dipped into or onto the metal, to provide a protective barrier from spatter and sparks. The Anti-Spatter Formulation is preferably brushed or sprayed on metal, to provide a protective barrier.

A chemical formula of the Anti-Spatter Formulation of the present invention includes soy lecithin and n-propyl bromide. Various strengths of the anti-spatter formulation product are accomplished by increasing the ratio of soy lecithin to n-propyl bromide.

Current anti-spatter products on the market can be water based which are not very effective. Other products contain a chemical such as methylene chloride, which is hazardous to the environment and humans. The ingredients in the Anti-Spatter Formulation of the present invention are generally considered to be non-ozone depleting and have a lower toxicity to humans.

Generally, in metal working, all manner of solid and liquid molten metal or sparks, capable of adhesion onto or damage to a metal surface, are known as “spatter,” or sometimes as “splatter.” Splatter is sometimes considered as greater in magnitude than spatter, but typically the two terms can be used interchangeably. Many metalworking operations involved in the manufacture of products do generate spatter such as welding, laser cutting or grinding. The anti-spatter formulation of the present invention provides a barrier that withstands spatter, and therefore protect the metal surface from damage.

In the operation of a laser cutting shop, an anti-spatter product must be used to protect the cut parts from spatter. When the laser cuts metals, a typical byproduct of the process is sparks of molten metal. Customers consider spatter and pits or related damage on the surface of the metal to be an unacceptable condition. From all available brands of anti-spatter products, the methylene chloride-based products are considered to perform the best. Unfortunately, methylene chloride is considered a cancer causing agent and makes some operators feel ill when it is used. As discussed above, a replacement anti-spatter product was needed. The Anti-Spatter Formulation of the present invention proves to provide a better barrier from spatter or splatter than the current or prior products, and exhibits no ill side-effects for the operators. The ingredients in the Anti-Spatter Formulation of the present invention are considered to be non-ozone depleting and have a lower toxicity to humans.

Current products can be water based which are not very effective. Other products contain a chemical such as methylene chloride which is hazardous to the environment and humans. The ingredients in the Anti-Spatter Formulation are considered to be non-ozone depleting and have a low toxicity to humans, especially when compared to conventional anti-spatter products.

Preferably, the Anti-Spatter Formulation of the present invention is brushed or sprayed on metal, to provide a protective barrier from spatter. As noted above, the Anti-Spatter Formulation is a chemical composition consisting of two ingredients: n-propyl-bromide, simply referred to herein as “NPB,” and soy lecithin, simply referred to herein as “Soy.”

In a preferred method of manufacture of the Anti-Spatter Formulation, these two ingredients are combined in a drum, at a ratio of 5 parts NPB, to 1 part Soy. This ratio is preferably a volume-to-volume ratio, as will be employed for ratios throughout this description. In an alternative embodiment of the present invention, the soy can be used straight, without dilution. However, various diluted ratios can be mixed to give more or less protection from spatter, as needed. Generally, to increase protection, one can increase the concentration of Soy relative to a solvent. The Soy is considered the component that actually protects the metal material the Anti-Spatter Formulation is applied to. The NPB apparently acts as a solvent to dissolves and emulsifies the Soy, so it can be applied to the metal easily, typically by sponge, brush, submersion, swab, or spraying.

“Lecithin” is a generic term to designate any group of yellow-brownish fatty substances occurring in animal and plant tissues, and in egg yolk, and is generally considered composed of phosphoric acid, choline, fatty acids, glycerol, glycolipids, triglycerides, and phospholipids. Commercially, lecithin can easily be extracted either chemically or mechanically, from readily available sources such as soy beans, to manufacture soy lecithin. For an alternative embodiment of the Anti-Spatter Formulation, it is assumed that other types or sources of lecithin could be utilized for the formulations of the present invention, including lecithin derived from eggs or from plant material other than soy beans. Lecithin can also be synthesized by employing standard industrial mechanisms and chemical processes. Typically, lecithin can be totally metabolized by humans, and so is well tolerated and non-toxic, even when ingested.

N-propyl-bromide, again simply referred to herein as “NPB,” is an organic solvent conventionally used for the cleaning of metal surfaces, removal of soldering residues from electronic circuit boards, and as an adhesive solvent. Manufacturers recommend 100 ppm as an occupational exposure level for NPB, which is the level at which personnel can work for an 8-hour working day without incurring undue health and safety problems. NPB is not considered as a “Hazardous Air Pollutant” or HAP in the United States, or in many other countries. HAP's have been identified by the U.S. Government as cancer-causing materials and therefore are under tighter environmental and personal exposure limits. Many companies are turning to NPB as a best alternative to HAP solvents.

Specifically, for the Anti-Spatter Formulation of the present invention, the following ratios are preferred, depending on the need of work product protections: For extreme duty and critical metal material surface protection, approximately 1 part NPB to 1 part Soy is utilized; for less critical, but still heavy duty protection of the metal material surface, approximately 3 parts NPB to 1 part Soy is preferably employed; for general purpose duty, approximately 5 parts NPB to 1 part Soy can be used; and for light duty protection of the surface of metal materials, 7 parts NPB to 1 part Soy can be applied. The terms “approximately” or “approximate” are employed herein throughout, including this detailed description and the attached claims, with the understanding that is denotes a level of exactness as typical for the skill and precision in the generally applicable field of technology.

The Anti-Spatter Formulation of the present invention is quickly and easily cleaned off of the surface of the metal material work piece, after welding or laser cutting. It can actually be used as a cleaner, to remove excess process oils, and trimmings or “swarf,” between operations. Importantly, the Anti-Spatter Formulation prevents adhesion of weld spatter, and provides a short to medium term indoor rust protection. This is especially important where a smooth appearance to the surface of the metal material is needed, and where fast mass production, such as “MIG” type welding operations are employed, or where large flat areas allow the spatter to remain in contact with the surface of the metal material work-piece.

The Anti-Spatter Formulation is a stable emulsion with good wetting properties, and dries to leave a thin, almost dry to touch film. In its preferred formulation, the Anti-Spatter Formulation does not contain any chlorine, boron, amine, nitrites, or formaldehyde and is not considered a health or environmental hazard under current legislation. In particular the Anti-Spatter Formulation does not contain harmful solvents such as di-chloromethane or dichloroethane. Conveniently, the Anti-Spatter Formulation can be used to fill and refill the user's own hand trigger sprays, to replace aerosol-type anti-spatter compounds, which results in a considerable savings as compared to aerosol type anti-spatter products, both in the purchase of the aerosol cans and in their disposal, after use. Using a refillable trigger spray also eliminates the release of aerosol propellant gases into the atmosphere, some of which are considered harmful to the environment.

In compliance with the statutes, the invention has been described in language more or less specific as to structural features and process steps. While this invention is susceptible to embodiment in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible, which employ the same inventive concepts as described above. Therefore, the invention is not to be limited except by the following claims, as appropriately interpreted in accordance with the doctrine of equivalents.

The following is claimed:

1. An anti-spatter formulation comprising of:
a lecithin; and
the anti-spatter formulation applied to a metal surface to form a barrier, the metal surface protected from a spark and spatter damage.

2. The anti-spatter formulation of claim 1, wherein the lecithin is a soy derived lecithin.

3. The anti-spatter formulation of claim 1, wherein the lecithin is mixed with an n-propyl bromide.

4. The anti-spatter formulation of claim 3, wherein the lecithin is mixed with the n-propyl bromide at a volume to volume ratio of up to 1 part soy lecithin to 7 parts n-propyl bromide.

5. The anti-spatter formulation of claim 1, wherein the metal working operation includes welding.

6. The anti-spatter formulation of claim 1, wherein the metal working operation includes laser cutting.

7. The anti-spatter formulation of claim 1, wherein the metal working operation includes grinding.

8. An anti-spatter formulation for protecting a metal surface with a spatter resistant barrier, the anti-spatter formulation comprising of:
a soy lecithin mixed with an n-propyl bromide; and
the spatter resistant barrier formed by the application of a coating of the anti-spatter formulation onto the metal surface, and the metal surface protected by the spatter resistant barrier from damage due to a molten spatter generated by a metal working operation proximate to the metal surface.

9. The anti-spatter formulation of claim 8, wherein the soy lecithin is mixed with the n-propyl bromide at a volume to volume ratio of up to 1 part soy lecithin to 7 parts n-propyl bromide.

10. The anti-spatter formulation of claim 8, wherein the metal working operation includes welding.

11. The anti-spatter formulation of claim 8, wherein the metal working operation includes laser cutting.

12. The anti-spatter formulation of claim 8, wherein the metal working operation includes grinding.
